(19) United States
(12) Patent Application Publication
(10) Pub. No.: US 2006/0066274 A1
(43) Pub. Date: Mar. 30, 2006

(54) Overmodulation of electric motor in power steering system

(75) Inventor: Sergei F. Kolomeitsev, Rochester, MI (US)

Correspondence Address: MATTHEW R. JENKINS, ESQ., 2310 FAR HILLS BUILDING, DAYTON, OH, 45419, US

(73) Assignee: VALEO ELECTRICAL SYSTEMS, INC., AUBURN HILLS, MI (US)

(21) Appl. No.: 10/955,617

(22) Filed: Sep. 30, 2004

(51) Int. Cl. H02P 7/00

(52) U.S. Cl. 318/432

(57) ABSTRACT

A control system for an electric motor, of the type used to deliver mechanical power to a power-steering system in a vehicle. In one form of the invention, at high motor speeds, an inverter is requested to deliver a pseudo-sinusoidal voltage having peak-to-peak value which a vehicle battery cannot attain. Consequently, the pseudo-sinusoidal voltage delivered to the motor is clipped at some value: the tops, and bottoms, of the pseudo-sinusoid peaks are chopped off. This clipping brings current in the phases closed to being in-phase with the voltage.

### BACKGROUND OF THE INVENTION

The invention concerns motors which supply power to a power steering system in a vehicle. The motors may be of the two-phase type. In such motors, the phases are independent of each other: the current and voltage in one phase are independent of the current and voltage in the other.

It is noted that the term “phase” refers to a coil in a motor, and also can refer to the “phase angle” between current and voltage. The context will make clear the meaning in any given situation.

At low speeds, a sinusoidal input voltage is applied to each phase of the motor. At high speeds, a sinusoidal voltage is demanded for each phase which exceeds the voltage which the vehicle's storage battery can supply. Consequently, the actual sinusoidal voltage delivered to the motor becomes clipped, or clamped, at some limiting level.

The clipping causes the current in the phase to which the voltage is applied to become closer in electrical phase angle with the voltage across the phase, compared with the non-clipped case. This increases torque in the motor or, from another perspective, decreases the current required for a given torque.

FIG. 1 is a schematic of the stator phases 3 of a prior-art three-phase motor, in which overmodulation is implemented. As indicated, three sinusoidal voltages 6 are applied to the three phases of the motor. By implementing overmodulation, the three voltages become clipped; the voltages do not reach their full peak values.

Implementation of this overmodulation in three-phase motors can be complex, expensive, and computabonally difficult. One reason is that the voltages in the three phases 3 are not independent. The phases 12 3 connected in the WYE-configuration, thereby making clipping difficult.

### OBJECTS OF THE INVENTION

An object of the invention is to provide an improved control system for an electric motor.

### SUMMARY OF THE INVENTION

In one form of the invention, modulation index of voltage applied to a motor is increased when a threshold speed is reached.

In one aspect, this invention comprises an apparatus, comprising an electric motor having independent phases, an inverter which delivers pseudo-sinusoidal voltage to the phases, and torque-boosting means for detecting whether motor speed exceeds a threshold and, if so, inducing clipping in the pseudo-sinusoidal voltage.

In still another aspect, this invention comprises an apparatus, comprising: an electric motor having phases, and means for increasing a modulation index of voltage supplied to the motor when direct current Id in the phases increases.

In yet another aspect, this invention comprises a method comprising the steps of maintaining an electric motor having independent phases, maintaining an inverter which delivers pseudo-sinusoidal voltage to the phases, and detecting whether motor speed exceeds a threshold and, if so, inducing clipping in the pseudo-sinusoidal voltage.

In still another aspect, this invention comprises an apparatus, comprising an electric motor having phases, and means for increasing modulation index of voltage supplied to the motor when direct current Id in the phases increases.

In yet another aspect, this invention comprises a method, comprising the steps of maintaining an electric motor having phases, and increasing modulation index of voltage supplied to the motor when direct current Id in the phases increases.

In still another aspect, this invention comprises method of operating an electric motor, comprising the steps of detecting whether motor speed has reached a first threshold T1, if the threshold T1 has been reached, continually increasing direct current Id in phases of the motor, as speed further increases, and increasing modulation index of voltage delivered to the motor as speed increases from threshold T1 to threshold T2, and then holding modulation index substantially constant above threshold T2.

In yet another aspect, this invention comprises an apparatus, comprising an electric motor, means for detecting whether motor speed has reached a first threshold T1, and if the threshold T1 has been reached, continually increasing direct current Id in phases of the motor, as speed further increases, and increasing modulation index of voltage delivered to the motor as speed increases from threshold T1 to threshold T2, and then holding modulation index substantially constant above threshold T2.

In still another aspect, this invention comprises an apparatus, comprising: a power supply delivering a voltage V, a motor having phase coils in a synchronous-type stator, a system for providing Field Oriented Control to the motor, and a controller for detecting whether motor speed exceeds a threshold and, if so, continually increasing Id as speed increases, and initially increasing modulation index of voltage applied to the motor as speed increases, and then holding modulation index constant.

In yet another aspect, this invention comprises a system, comprising an electric motor, a controller which at speeds below a threshold T1, delivers voltage to the motor at a modulation index of 1.0 and maintains direct current, Id, at zero, at speeds above threshold T1 and below threshold T2, delivers voltage to the motor at a modulation index exceeding 1.0 and increasing with motor speed, and maintains direct current, Id, above zero, and at speeds above threshold T2, delivers voltage to the motor at a modulation index exceeding 1.0 and held fixed, and maintains direct current, Id, above zero.

Other objects and advantages of the invention will be apparent from the following description and the accompanying drawings.

### BRIEF DESCRIPTION OF THE DRAWINGS

FIG. 1 illustrates schematically overmodulation which exists in the prior art, in three-phase motors.

FIG. 2 illustrates stator phase coils in a two-phase motor.

FIG. 3 illustrates a prior-art vehicle, in which an electric motor supplies mechanical power to a power steering linkage 24.

FIG. 4 is an equivalent circuit of a phase 27 in FIG. 2.

FIG. 5 illustrates voltages and currents found in the equivalent circuit of FIG. 4.

FIG. 6 illustrates how the invention alters the voltages and currents of FIG. 5.

FIG. 7 illustrates a demanded voltage Vdemand, which is generated by the controller 42 of FIG. 8A.

FIG. 8 illustrates how the clipping of FIG. 7 can be viewed as creating a trapezoidal waveform.

FIG. 8A is a schematic of a controller and inverter which drive a motor.

FIGS. 9-11 are plots of sinusoids and provide a definition of modulation index.

FIG. 12 illustrates behavior of one form of the invention.

FIG. 13 is a representation of stator phases in a two-phase motor.

FIG. 14 illustrates magnetic fields Ba and Bb produced by the stator phases.

FIG. 15 illustrates how magnetic fields Ba and Bb add vectorially to a resultant Br.

FIG. 16 illustrates a rotating coordinate system superimposed on resultant Br, to express Br in terms of different vectors u and v.

FIG. 17 illustrates a rotor R superimposed on the rotating coordinate system.

FIG. 18 illustrates behavior of one form of the invention.

### DETAILED DESCRIPTION OF THE INVENTION

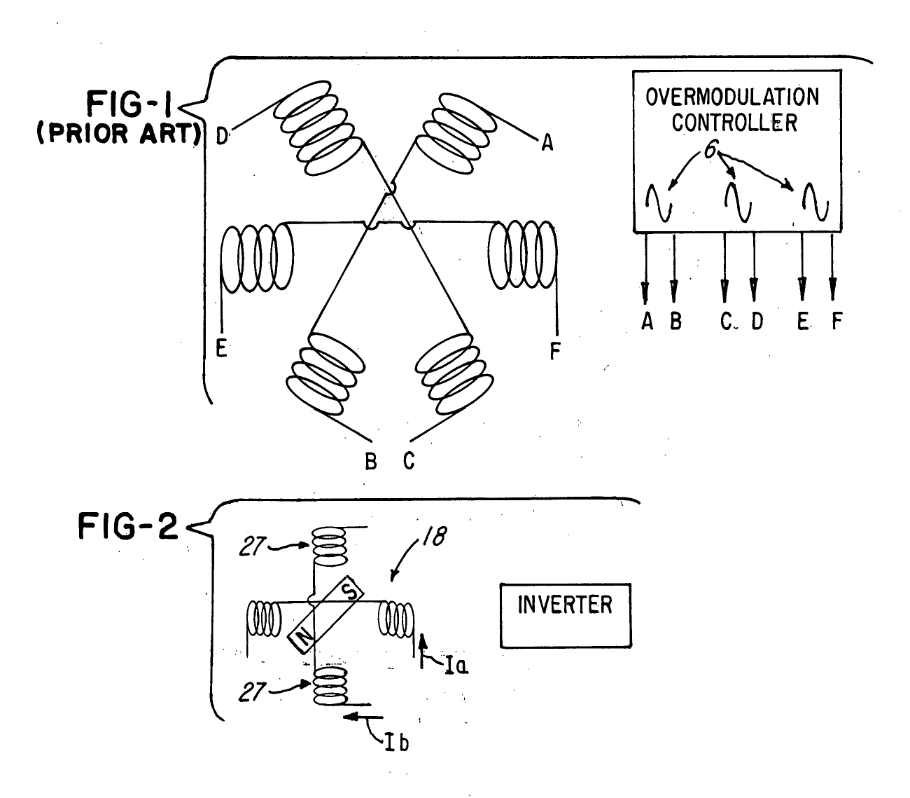

FIG. 2 illustrates schematically the stator phases 18 of a two-phase, permanent magnet, brushless, DC electric motor, indicated as block 21 in FIG. 3. Such a motor can be used in a motor vehicle 22, to drive a mechanical linkage 24, to provide power assist in the steering system. Such a power assist is commonly called “power steering.”

The motor is powered by an inverter 25, which receives DC power from the vehicle battery (not shown) and which produces a waveform which resembles a sinusoid, and will be called pseudo-sinusoidal. The motor 21 runs at synchronous speed with the pseudo-sinusoid.

FIG. 4 is a conventional representation of one phase 27 of the motor 18 in FIG. 2. Resistor 30 in FIG. 4 represents the resistance of the wires in the phase 27 of FIG. 2. Voltage source 33 in FIG. 4 represents the Electro Motive Force, EMF, developed in the inductance of the phase 27.

The EMF is produced by two primary agencies. One is the back-EMF caused by the time-changing input voltage applied to the phase by the power supply, or inverter, which powers the motor 21. This input voltage is the pseudo-sinusoidal voltage discussed above and is applied at point P in FIG. 4.

The second agency is the voltage caused by the relative rotation between the inductance within the phase 27 and a magnetic field (not shown) produced by the permanent magnets (not shown) contained within the motor 21. The second agency, in effect, is a type of generator action within the motor.

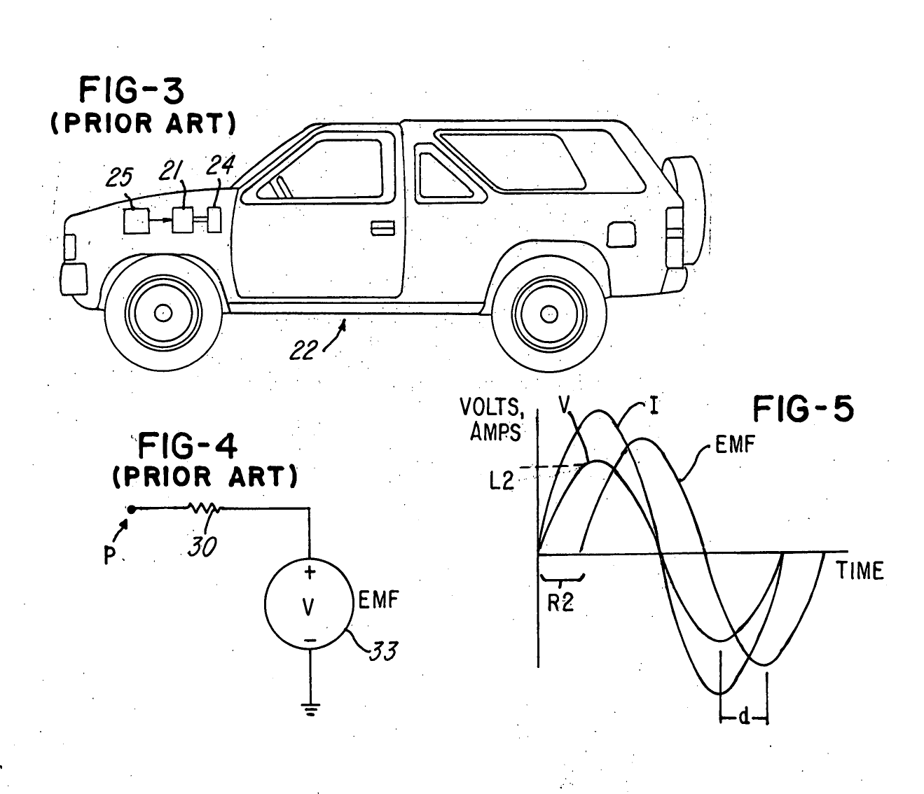

FIG. 5 is the Inventor's schematic representation of various currents and voltages in the phase 27 of FIG. 2, in one mode of operation. The plot of voltage V represents the input voltage applied to the terminals of the motor. In FIG. 4, this voltage is applied to point P.

The plot of current I in FIG. 5 represents the current in the phase 27. The plot labeled EMF represents the voltage across the phase, indicated as EMF in FIG. 4, and is attributed to the two agencies identified above.

Two significant features of the plot are the following. One is that the current I is relatively high, compared with the current in a plot discussed later. The second feature is that the current I is significantly out-of-phase with the EMF. Distance d represents the phase angle. It is well known that power delivered is maximized when the current and the EMF are in-phase, that is, are at a zero phase angle with respect to each other.

Therefore, to repeat in different terms, the current I is relatively high, and thus expensive. Also, the current is not utilized to its maximal possible advantage, because it is not in-phase with the EMF.

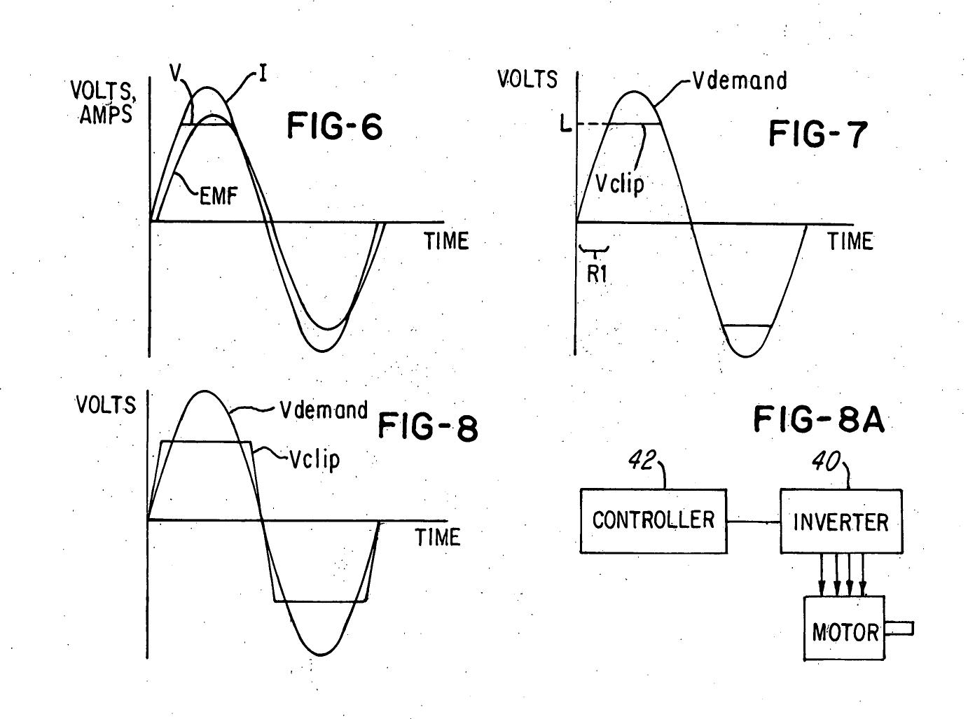

FIG. 6 is a plot of the parameters of FIG. 5, but as produced by one form of the invention. The voltage V, applied to the input terminals of the motor, is clipped. That is, the voltage V which is demanded to be applied to the terminals of the motor is represented by Vdemand in FIG. 7. However, since the power supply of the vehicle, namely, the primary storage battery, cannot supply the voltage demanded, the actual voltage delivered is represented by Vclip. Vclip is clamped at level L.

This clipping can be achieved by the apparatus schematically represented in FIG. 8A. An inverter 40 comprising one or more know transistors (not shown) provides an input voltage to each phase of the motor which is suitably close to sinusoidal. Logic circuitry 42, which can take the form of a small computer, controls the inverter 40, and thus controls the magnitude and phase of the voltage applied to the motor. The invention causes the logic circuitry 42 to demand a voltage which is sufficiently high that the desired amount of clipping occurs, as indicated in FIG. 7.

The Inventor points out that the clipping causes the slope of Vclip in region R1 in FIG. 7 to be larger than the slope of a sinusoidal voltage having a peak value of L. That is, for example, assume that both plots I and V in FIG. 5 represent voltage. Plot I is clipped at level L2. (Clipping is not shown.) The slope of plot I in region R2 is greater than the slope of plot V in that region.

Conceptually, one form of the invention can be viewed as applying a trapezoidal waveform to the motor, as indicated in FIG. 8.

The amount of clipping can be quantified by assigning a parameter known as modulation index to the clipped waveform. Modulation index is defined in the motor art as the ratio of (1) the fundamental term of the Fourier series which represents a non-clipped sinusoid to (2) the fundamental term of the Fourier series which represents a clipped sinusoid.

For example, let the fundamental term of the non-clipped sinusoid be (A0)sin(wt), wherein A0 is the amplitude, w is angular frequency (radians per second), and t is time. Let the fundamental of the clipped sinusoid be (B0)sin(wt). The modulation index is then B0/A0.

It should be noted that the sinusoids just discussed are true sinusoids, not pseudo-sinusoids. However, since the inductance of the motor phases smoothes out the pseudo-sinusoids into near-sinusoids, this definition is applicable.

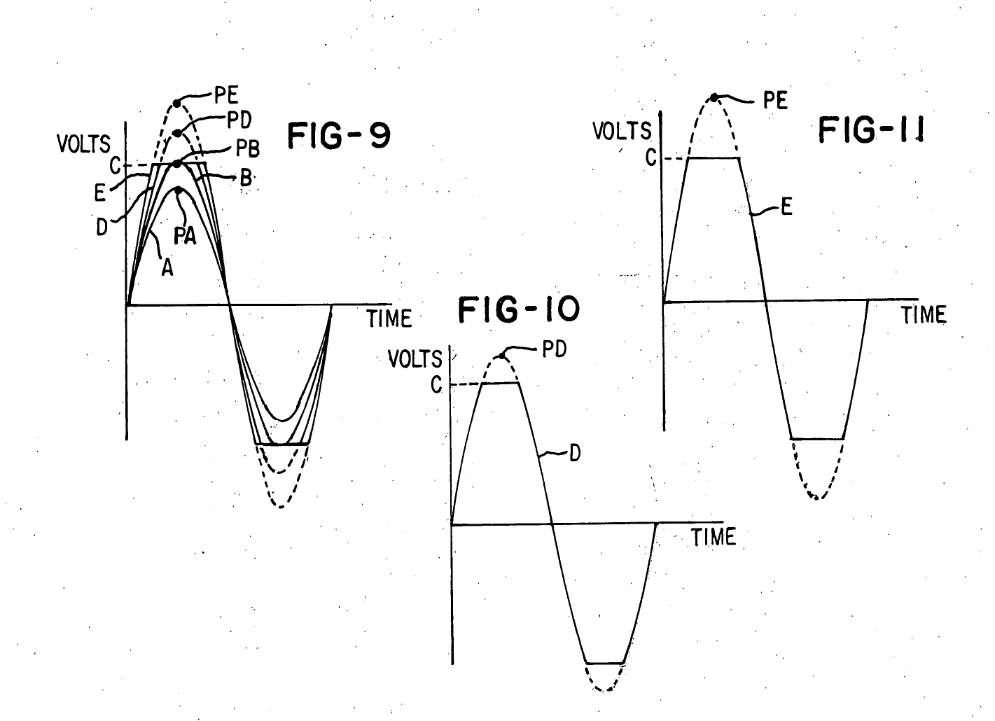

Another definition of modulation index can be the ratio of peak voltage demanded during clipping to clipped voltage. FIGS. 9-11 illustrate this definition.

Symbol C represents the clipping level. In plot A, peak voltage PA is attained, and no clipping occurs. In plot B, the demanded voltage is higher, and peak voltage PB is attained. The onset of clipping occurs. In plot D, the demanded voltage is yet higher, and the dashed part of the plot is cut off. FIG. 10 illustrates plot D by itself for clarity.

In plot E, the demanded voltage is yet higher, and the dashed part of the plot is again cut off. FIG. 11 illustrates plot D by itself for clarity.

Under this definition, the modulation index for the demanded voltage of plot D would be PD/C, wherein PD is the peak voltage demanded and C is the clipping level.

### Significant Features

1. The clipping, by distorting the shape of the voltage input, induces torque ripple. When the invention is used in the power steering system of a vehicle, this ripple can be detected by the driver at low speeds. However, under the invention, at low speeds, non-clipped waveforms are used, which produce minimal torque ripple. At higher speeds, clipped waveforms are used, which produce torque ripple. But the torque ripple is damped out by the flywheel effect of the rotating mass of the motor.

2. FIG. 12 illustrates one mode of operation of the invention. When motor speed is below threshold T1, both Id and modulation index are held at unity. Id is a parameter used in Field Oriented Control, FOC, of motors, and will be explained.

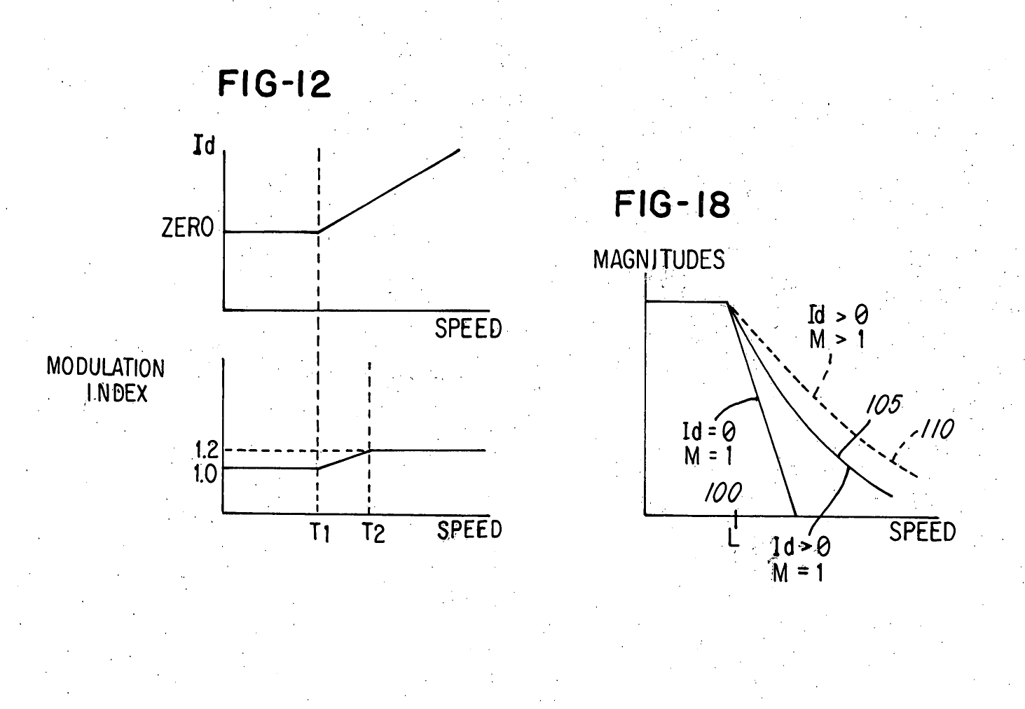

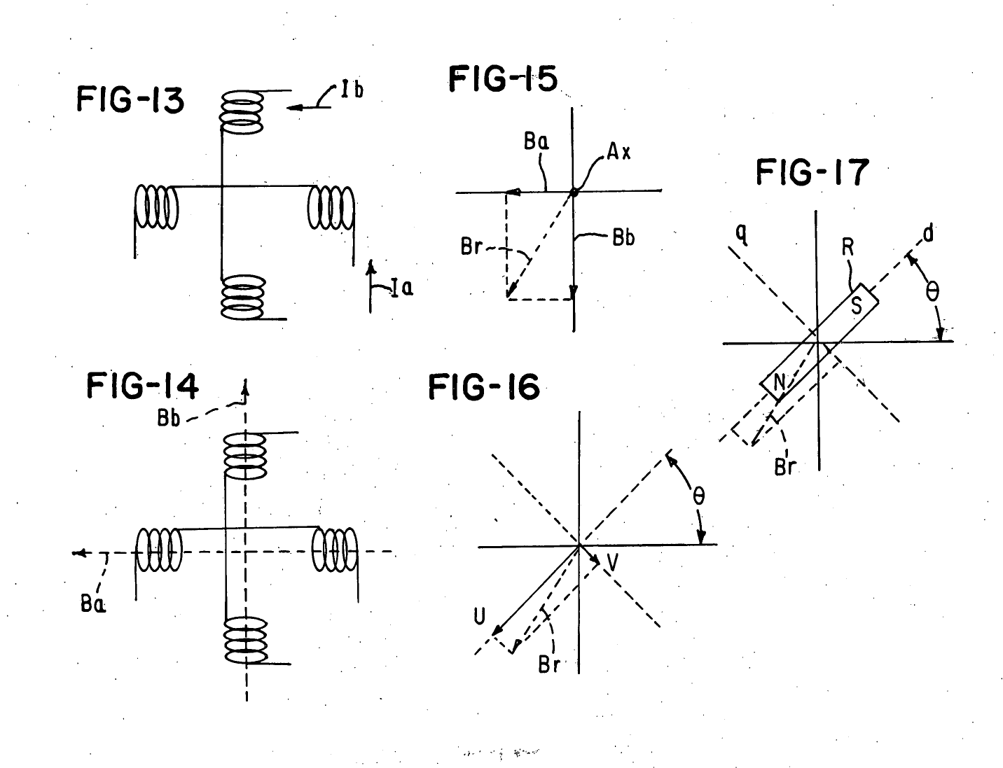

FIG. 13 illustrates the phases in a two-phase motor (not shown). Currents Ia and Ib are shown. Those currents produce the magnetic fields Ba and Bb in FIG. 14. Those two magnetic fields add vectorially as shown in FIG. 15, to produce a resultant vector Br. That resultant Br, in general, represents the stator field, which rotates about the axis Ax of the motor.

In FIG. 15, the directions of components Ba and Bb of vector Br are stationary in space. That is, components Ba and Bb always point in the same directions (or 180 degrees opposite those directions), and only change in magnitude, not direction.

In Field Oriented Control, it is desirable to express the resultant Br in terms of two components which rotate along with the rotor (not shown) of the motor. Such a representation would place the two new components in a rotating coordinate system which is stationary with respect to the rotor.

The dashed coordinate system in FIG. 16 is such a coordinate system, rotating along with the rotor, as angle theta changes over time. The two new component vectors are u and v, which sum vectorially to Br.

FIG. 17 illustrates the rotor R, represented as a magnet, superimposed on the rotating coordinate system. The two axes of the rotating coordinate system are termed d- and q-axes. The d-axis is the direct axis because it is aligned with the magnetic field (not shown) of the rotor R. The q-axis is in quadrature with the d-axis, explaining the designation “q.”

Id is the current needed to produce the direct component u in FIG. 16, that is, the current which produces a magnetic field u, which lies along the d-axis, and is aligned with the magnetic field (not shown) or magnet R in FIG. 17.

It is noted that Id does not, in general, exist as a separate current. That is, only currents Ia and Ib in FIG. 13 are under control of the designer. For given Ia and Ib, a given Br in FIG. 15 results. For that Br, and a given theta in FIG. 16, a given u in FIG. 16 will be computed. The parameter u corresponds, in general, after a conversion for units, to Id.

Thus, if a given Id is desired, a backward computation, as it were, is undertaken from FIG. 16, through FIG. 13, to determine the required Ia and Ib to provide the desired Id.

Thus, having explained the basic nature of Id, the Inventor returns to FIG. 12, which shows that Id is initially held at zero. But as motor speed increases above threshold T1, Id is then increased.

In addition, when motor speed passes threshold T1, the modulation index is then also increased, but only until threshold T2 is reached. Thereafter, modulation index is held constant, for example, at 1.2, or twenty percent above a modulation index of 1.0, which represents zero modulation. Preferably, the modulation index never exceeds 40 percent.

It is also noted that Id can be zero during certain modes of operation. That is, in some modes of operation, the stator field is desired to be held at ninety degrees ahead of the rotor field. Thus, the stator field in FIG. 17 would lie along the q-axis. There would be no component along the d-axis, which is parallel with the rotor field (not shown). Thus, in this instance, Id would be zero.

3. FIG. 18 illustrates three plots representing three modes of operation of one form of the invention.

In plot 100, torque drops after a limit L in motor speed is reached, because Id is held at zero during the drop.

In plot 105, torque also drops, but not so precipitously as in plot 100. The reason is that Id is held above zero (that is, a magnetic field component along the d-axis in FIG. 17 is now present), while the modulation index M is held at unity.

In plot 110, the drop in torque is still less than in plots 100 and 105. Modulation index M is held above unity, preferably between 1.00 and 1.20, and Id is above zero.

4. FIGS. 5 and 6 are approximately to scale. It is seen that the peak value of the current I in FIG. 6 is less than the peak value in FIG. 5. Thus, not only is less current consumed, but less current flows through the transistors in the inverter 40 (FIG. 8A) which supplies the current, meaning that less expensive transistors can be used.

Numerous substitutions and modifications can be undertaken without departing from the true spirit and scope of the invention. What is desired to be secured by Letters Patent is the invention as defined in the following claims.

1. An apparatus, comprising:
a) an electric motor having independent phases;
b) an inverter which delivers pseudo-sinusoidal voltage to the phases; and
c) torque-boosting means for detecting whether motor speed exceeds a threshold and, if so, inducing clipping in the pseudo-sinusoidal voltage.

2. The apparatus according to claim 1, wherein the inverter receives input power from a battery, and the torque-boosting means causes the clipping by demanding a peak voltage in the pseudo-sinusoidal voltage which the battery cannot deliver.

3. The apparatus according to claim 1, and further comprising a linkage which controls steerable wheels in a vehicle, and in which the motor powers the linkage.

4. The apparatus according to claim 1, and further comprising:
d) means for increasing direct current Id in the phases during clipping.

5. An apparatus comprising:
a) an electric motor having phases; and
b) means for increasing modulation index of voltage supplied to the motor when direct current Id in the phases increases.

6. A method, comprising the steps of:
a) maintaining an electric motor having independent phases;
b) maintaining an inverter which delivers pseudo-sinusoidal voltage to the phases; and
c) detecting whether motor speed exceeds a threshold and, if so, inducing clipping in the pseudo-sinusoidal voltage.

7. The method according to claim 6, wherein the inverter receives input power from a battery, and the torque-boosting means causes the clipping by demanding a peak voltage in the pseudo-sinusoidal voltage which the battery cannot deliver.

8. The method according to claim 6, and further comprising
d) maintaining a linkage which controls steerable wheels in a vehicle, wherein the motor powers the linkage.

9. The apparatus according to claim 6, and further comprising:
d) increasing direct current Id in the phases during clipping.

10. An apparatus comprising:
a) an electric motor having phases; and
b) means for increasing modulation index of voltage supplied to the motor when direct current Id in the phases increases.

11. A method comprising the steps of:
a) maintaining an electric motor having phases; and
b) increasing modulation index of voltage supplied to the motor when direct current Id in the phases increases.

12. A method of operating an electric motor, comprising:
a) detecting whether motor speed has reached a first threshold T1;
b) if the threshold T1 has been reached,
i) continually increasing direct current Id in phases of the motor as speed further increases; and
ii) increasing modulation index of voltage delivered to the motor as speed increases from threshold T1 to threshold T2, and then holding modulation index substantially constant above threshold T2.

13. An apparatus, comprising:
a) an electric motor;
b) means for detecting whether motor speed has reached a first threshold T1, and if the threshold T1 has been reached,
i) continually increasing direct current Id in phases of the motor, as speed further increases; and
ii) increasing modulation index of voltage delivered to the motor as speed increases from threshold T1 to threshold T2, and then holding modulation index substantially constant above threshold T2.

14. The apparatus according to claim 1, wherein the motor is the permanent-magnet, two-phase, brushless, DC type.

15. The apparatus according to claim 10, wherein the motor is the permanent-magnet, two-phase, brushless, DC type.

16. The method according to claim 11, wherein the motor is the permanent-magnet, two-phase, brushless, DC type.

17. The method according to claim 12, wherein the motor is the permanent-magnet, two-phase, brushless, DC type.

18. The apparatus according to claim 13, wherein the motor is the permanent-magnet, two-phase, brushless, DC type.

19. An apparatus comprising:
a) a power supply delivering a voltage V;
b) a motor having phase coils in a synchronous-type stator;
c) a system for providing Field Oriented Control to the motor; and
d) a controller for detecting whether motor speed exceeds a threshold and, if so,
i) continually increasing Id as speed increases; and
ii) initially increasing modulation index of voltage applied to the motor as speed increases, and then holding modulation index constant.

20. The apparatus according to claim 19, and further comprising:
e) a vehicle equipped with a power steering system, wherein the motor provides power to the power steering system.

21. A system comprising:
a) an electric motor;
b) a controller which
i) at speeds below a threshold T1, delivers voltage to the motor at a modulation index of 1.0 and maintains direct current, Id, at zero;
ii) at speeds above threshold T1 and below threshold T2, delivers voltage to the motor at a modulation index exceeding 1.0 and increasing with motor speed, and maintains direct current, Id, above zero; and
iii) at speeds above threshold T2, delivers voltage to the motor at a modulation index exceeding 1.0 and held fixed, and maintains direct current, Id, above zero.

22. The system according to claim 21, wherein, between thresholds T1 and T2, direct current Id increases with speed.

23. The system according to claim 21, wherein, above threshold T2, direct current Id increases with speed.
